(19) United States
(12) Patent Application Publication
(10) Pub. No.: US 2008/0084525 A1
(43) Pub. Date: Apr. 10, 2008

(54) Liquid crystal display panel

(75) Inventor: Norihisa Yamada, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/906,507

(22) Filed: Oct. 2, 2007

(30) Foreign Application Priority Data
Oct. 4, 2006 (JP) 2006-272752

(51) Int. Cl. G02F 1/1335; G02F 1/13

(52) U.S. Cl. 349/110; 349/187

(57) ABSTRACT

A liquid crystal display panel includes a substrate provided with a transfer pad, a countersubstrate provided with a black mask, and a transfer arranged between the transfer pad of the substrate and the black mask of the countersubstrate. The transfer pad includes slits allowing a normal transfer to be seen from a substrate side.

### CROSS-REFERENCE TO RELATED APPLICATIONS

This application is based upon and claims the benefit of priority from prior Japanese Patent Application No. 2006-272752, filed Oct. 4, 2006, the entire contents of which are incorporated herein by reference.

### BACKGROUND OF THE INVENTION

1. Field of the Invention

The present invention relates to a liquid crystal display.

2. Description of the Related Art

Generally, in an active matrix liquid crystal display panel that uses a thin-film transistor (to be referred to as a TFT hereinafter) as a switching element, a TFT substrate provided with the TFT, and a countersubstrate having a black mask, a color filter, and a counterelectrode are arranged to oppose each other through a liquid crystal.

The counterelectrode of the countersubstrate of the liquid crystal display panel is connected to the TFT substrate through a transfer mixed with a conducting agent. The process requires determinations as to whether the transfer is applied, whether a correct amount of transfer is applied, whether the transfer is applied to a correct position, and the like.

The structure of a transfer pad provided to a TFT substrate in a conventional liquid crystal display panel will be described with reference to the accompanying drawing.

FIG. 8A is a plan view of a transfer pad 100 according to the first prior art seen from a TFT substrate 200 side, FIG. 8B is a plan view of the transfer pad 100 according to the first prior art seen from a countersubstrate 300 side, and FIG. 9 is a sectional view taken along the lines IX-IX′ of FIGS. 8A and 8B.

A first metal film 201 is deposited at a predetermined position on the TFT substrate 200, and a gate film 202 is formed on the first metal film 201. The gate film 202 is partially etched to form a through hole through which the first metal film 201 is to be electrically connected to a second metal film 203. The second metal film 203 is formed on the gate film 202 to have a predetermined shape, in the same manner as the first metal film 201. Subsequently, a passivation film 204 is formed. Part of the passivation film 204 has been removed to electrically connect the metal films to a transfer 101. More specifically, as shown in FIG. 9, the metal portions 201 and 203 that are electrically connected to the transfer 101 constitute a transfer pad 100. The transfer pad 100 is connected to a common potential input terminal through both the first metal film 201 and second metal film 203.

The countersubstrate 300 is provided with a black mask 102 and a color filter (not shown) on an inner surface. The black mask 102 is partially removed to form a transfer confirmation window 103 through which the presence/absence and amount of the transfer 101 and the relative positional error between the transfer pad 100 and the countersubstrate 300 can be confirmed (see FIGS. 8A, 8B, and 9).

In the vicinity of the outer periphery of the countersubstrate 300, a seal made of an adhesive is formed along the edge. The transfer 101 is formed at a corner of the countersubstrate 300. The transfer 101 serves to electrically connect the transfer pad 100 formed on the TFT substrate 200 to a counterelectrode 301 formed on the countersubstrate 300. After that, a liquid crystal is filled between the two substrates 200 and 300 described above, and the resultant structure is sealed to form a liquid crystal display panel.

A polarizing plate, a driving circuit, a box, and the like are added to the liquid crystal display panel to form a liquid crystal display apparatus. When the liquid crystal display panel is assembled as a liquid crystal display apparatus, the user observes the display from the glass surface of the countersubstrate 300.

As described above, in the liquid crystal display panel according to the first prior art, the black mask 102 is partially removed to form the transfer confirmation window 103 through which the shape and presence/absence of the transfer 101 can be confirmed. This allows visual confirmation of the process management or the like of the transfer 101 from the countersubstrate 300 side even after the liquid crystal display panel is assembled.

In this case, when the user observes the display surface of the liquid crystal display panel, i.e., the glass surface of the countersubstrate 300, the transfer 101 having a reflectance comparatively higher than that of the black mask 102 or of the polarizing plate tends to be visually confirmed through the transfer confirmation window 103 formed in the black mask 102. More specifically, light is undesirably transmitted through a black-mask-free portion (transfer confirmation window 103), and is reflected by the metal film of the TFT substrate side. This impairs the quality of the appearance.

In order to solve this problem, a second prior art is available. According to the second prior art, the structure of the transfer pad is changed so that the process management or the like of the transfer can be performed from the TFT substrate side.

FIG. 10A is a plan view of a transfer pad disclosed in Jpn. Pat. Appln. KOKAI Publication No. 2000-89247 as the second prior art seen from a TFT substrate 600 side, FIG. 10B is a plan view of the transfer pad according to the second prior art seen from a counterelectrode 700 side, and FIG. 11 is a sectional view taken along the lines XI-XI′ of FIGS. 10A and 10B.

A first metal film 601 is deposited at a predetermined position on the TFT substrate 600. The first metal film 601 at a region corresponding to the position where a transfer 501 is to be formed has been removed. A gate insulating film 602 is formed on the first metal film 601. The gate insulating film 602 is partially etched to form a through hole through which the first metal film 601 is to be electrically connected to a second metal film 603. The second metal film 603 is formed on the gate insulating film 602 to have a predetermined shape, in the same manner as the first metal film 601. The second metal film 603 at a region corresponding to the position where the transfer 501 is to be formed has been removed, in the same manner as that described above. Then, a transparent conductive film 606 is formed to cover the second metal film 603. Subsequently, a passivation film 604 is formed. Part of the passivation film 604 on the transparent conductive film 606 has been removed to electrically connect the metal films to the transfer 501. More specifically, as shown in FIG. 11, that portion of the transparent conductive film 606 that is electrically connected to the transfer 501 constitutes a transfer pad. The transfer pad is connected to a common potential input terminal through the transparent conductive film 606, the first metal film 601, and the second metal film 603.

The countersubstrate 700 of a glass substrate is provided with a black mask 502 and a color filter (not shown). The black mask 502 is not provided with a transfer confirmation window through which the presence/absence and shape of the transfer 501 can be confirmed (see FIGS. 10A, 10B, and 11).

In the vicinity of the outer circumference of the countersubstrate 700, a seal made of an adhesive is formed along the edge. The transfer 501 is formed at a corner of the countersubstrate 700. The transfer 501 serves to electrically connect the transfer pad formed on the TFT substrate 600 to a counterelectrode 701 formed on the countersubstrate 700. After that, a liquid crystal is filled between the two substrates described above, and the resultant structure is sealed to form a liquid crystal display panel.

A polarizing plate, a driving circuit, a box, and the like are added to the liquid crystal display panel to form a liquid crystal display apparatus. When the liquid crystal display panel is assembled as a liquid crystal display apparatus, the user observes the display from the glass surface of the countersubstrate 700.

In the second prior art, the presence/absence and amount of the transfer 501, and the relative positional error between the transfer pad and the countersubstrate 700 are determined from the TFT substrate 600 side. The central portions of the metal films 601 and 603 on the TFT substrate 600 that form the transfer pad, that is, the metal films in the region corresponding to the position where the transfer 501 is to be formed, are removed to form a transfer confirmation window 503. This allows visual confirmation of the process management or the like of the transfer 501 from the TFT substrate 600 side even after the liquid crystal display panel is assembled. Also, since no confirmation window is formed in the black mask, the quality of the appearance is not impaired.

However, since the metal films 601 and 603 are removed, and only the transparent conductive film 606 having a comparatively high resistance is connected to the transfer 501, the resistance tends to increase, which is disadvantageous in terms of electrical connection. The transfer confirmation window 503 formed in the transfer pad must have such a size that the entire transfer 501 can be seen through it. This inevitably increases the diameter of the transfer pad. Consequently, the entire liquid crystal display panel is difficult to downsize.

### BRIEF SUMMARY OF THE INVENTION

A liquid crystal panel according to an aspect of the present invention includes a substrate provided with a transfer pad, a countersubstrate provided with a black mask, and a transfer arranged between the transfer pad of the substrate and the black mask of the countersubstrate. The transfer pad includes slits allowing a normal transfer to be seen from a substrate side.

Additional objects and advantages of the invention will be set forth in the description which follows, and in part will be obvious from the description, or may be learned by practice of the invention. The objects and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a plan view of a transfer pad according to the present invention seen from a TFT substrate side;

FIG. 1B is a plan view of the transfer pad according to the present invention seen from a countersubstrate side;

FIG. 2 is a sectional view taken along the lines II-II′ of FIGS. 1A and 1B;

FIG. 3 is a plan view of the transfer pad, seen from the TFT substrate side, when the finish diameter of a transfer decreases due to apparatus variations;

FIG. 4 is a sectional view taken along the line IV-IV′ of FIG. 3;

FIG. 5 is a plan view of the transfer pad, seen from the TFT substrate side, when a transfer error occurs due to apparatus variations;

FIG. 6 is a sectional view taken along the line VI-VI′ of FIG. 5;

FIG. 7A is a plan view showing a transfer pad shape (with three slits);

FIG. 7B is a plan view showing a transfer pad shape (with five slits);

FIG. 7C is a plan view showing a transfer pad shape (the transfer pad is square);

FIG. 8A is a plan view of a transfer pad according to the first prior art seen from a TFT substrate side;

FIG. 8B is a plan view of the transfer pad according to the first prior art seen from a countersubstrate side;

FIG. 9 is a sectional view taken along the lines IX-IX′ of FIGS. 8A and 8B;

FIG. 10A is a plan view of a transfer pad according to the second prior art seen from a TFT substrate side;

FIG. 10B is a plan view of the transfer pad according to the second prior art seen from a countersubstrate side; and

FIG. 11 is a sectional view taken along the lines XI-XI′ of FIGS. 10A and 10B.

### DETAILED DESCRIPTION OF THE INVENTION

The structure of a transfer pad for a liquid crystal display panel according to the present invention will be described in detail by showing its embodiment.

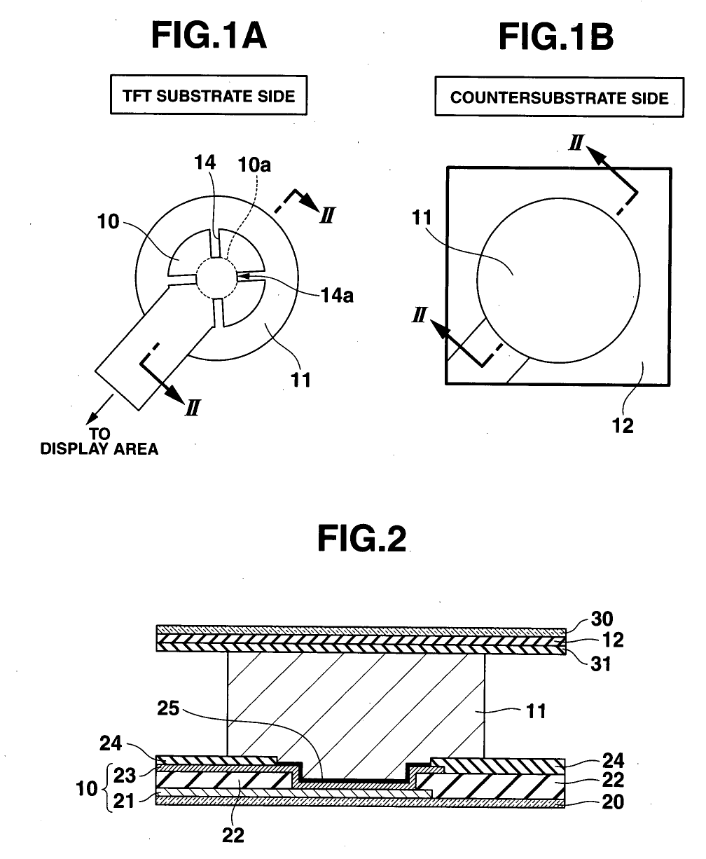

FIG. 1A is a plan view of a transfer pad 10 according to the present invention seen from a TFT substrate 20 side, FIG. 1B is a plan view of the transfer pad 10 according to the present invention seen from a countersubstrate 30 side, and FIG. 2 is a sectional view taken along the lines II-II′ of FIGS. 1A and 1B.

A TFT substrate 20 formed of a transparent glass substrate has a TFT including a gate electrode, a source electrode, and a drain electrode, and a pixel electrode in a pixel region on a surface that opposes a countersubstrate 30 similarly formed of a transparent glass substrate. A first metal film 21 is deposited at a predetermined position on the peripheral portion of the pixel region of the TFT substrate 20, and a gate insulating film 22 is formed on the first metal film 21. The gate insulating film 22 is partially etched to form a through hole through which the first metal film 21 is to be electrically connected to a second metal film 23. The second metal film 23 is formed on the gate film 22 to have a predetermined shape, in the same manner as the first metal film 21. One of the first and second metal films 21 and 23 is made of a gate metal deposited to form the gate electrode of the TFT, and the other is formed of a source metal and drain metal deposited to form the source and drain electrodes of the TFT. Subsequently, a passivation film 24 made of silicon nitride or the like is formed to cover the TFT. Part of the passivation film 24 has been removed to electrically connect the first and second metal films 21 and 23 to a transfer 11. More specifically, as shown in FIG. 2, the metal portions 21 and 23 that overlap the transfer 11 to be electrically connected to it constitute a transfer pad 10. The transfer pad 10 is connected to a common potential input terminal through both the first and second metal films 21 and 23.

As shown in FIG. 1A, the transfer pad 10 has slits 14 as notches that are open in the outer periphery of the transfer pad 10. The respective slits 14 are formed so that slit terminal ends 14a as their innermost portions are spaced part from each other. Thus, the transfer pad 10 has a region 10a (a circle in FIG. 1A) that is located at the center to be surrounded by the slits 14 and that includes the slit terminal ends 14a as part of its edge.

The region 10a of the transfer pad 10 is set to coincide with a region of the transfer 11 formed on the transfer pad 10 when the transfer 11 takes a maximal diameter among small diameters that cause the transfer 11 to have such a high resistant state to cause a problem in the electrical connection between the transfer pad 10 and a counterelectrode 31. In other words, when forming the transfer 11 on the transfer pad 10, assume that the transfer 11 has such a size that it laps out of the slit terminal ends 14a of the slits 14 and is thus detectable. In this case, the transfer 11 has a diameter large enough to electrically connect the transfer pad 10 and counterelectrode 31 well. Thus, this panel is determined as a nondefective product (G). If the transfer 11 does not lap out of the slit terminal ends 14a but is hidden by the region 10a, it may cause a problem in electrical connection. Thus, this panel is determined as a defective product (NG). Thus, the diameter of the region 10a coincides with the maximal diameter (to be referred to as maximal NG diameter) of the transfer 11 with which the panel is determined as NG due to defective connection.

The slits 14 outwardly extend from the edge of the region 10a radially. More specifically, the respective slits 14 are formed in the outer periphery of the transfer pad 10 to extend toward the center of the transfer pad 10. The opposing ones of the slits 14 may be arranged on the straight lines of the transfer pad 10 to form pairs. Alternatively, when the respective slits 14 may be arranged so that the slit terminal ends 14a are located on the outer circumference of the maximal NG diameter when the transfer 11 is arranged with its center being located at the center of the transfer pad 10. The slits 14 need not be linear but may be curved.

A black mask 12 and a color filter (not shown) are formed on the countersubstrate 30. The black mask 12 is not provided with a transfer confirmation window through which the presence/absence and shape of the transfer 11 can be confirmed (see FIG. 1A).

In the vicinity of the outer periphery of the countersubstrate 30, a seal made of an adhesive is formed along the edge. The transfer/s 11 is/are formed at one to four corners of the countersubstrate 30. The transfer 11 serves to electrically connect the transfer pad 10 formed on the TFT substrate 20 to the counterelectrode 31 formed on the countersubstrate 30. After that, a liquid crystal is filled between the two substrates described above, and the resultant structure is sealed to form a liquid crystal display panel.

A polarizing plate, a driving circuit, a box, and the like are added to the liquid crystal display panel to form a liquid crystal display apparatus. When the liquid crystal display panel is assembled as a liquid crystal display apparatus, the user observes the display from the glass surface of the countersubstrate 30.

The present invention is superior to the prior art in confirming the presence/absence and amount of the transfer, and the relative positional error between the transfer pad 10 and countersubstrate 30.

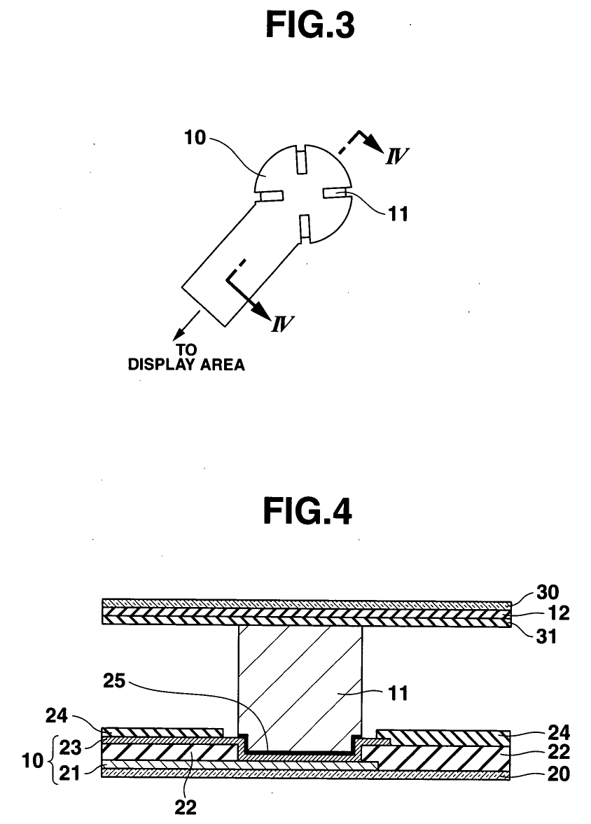

FIG. 3 is a plan view of the transfer pad 10, seen from the TFT substrate 20 side, when the finish diameter of the transfer 11 decreases due to apparatus variations, and FIG. 4 is a sectional view taken along the line IV-IV′ of FIG. 3.

Originally, in the manufacturing process of a liquid crystal display panel, if the diameter of the transfer 11 is smaller than that of the transfer pad 10, the presence/absence of the transfer 11 cannot be confirmed from the TFT substrate side. Accordingly, in the process, such a panel is determined to be NG. If forming the slits 14 not within a predetermined diameter from the center of the transfer pad 10 but outside the predetermined diameter (for example, forming the slits 14 radially outside the maximal NG diameter), the transfer 11 that has a diameter smaller than that of the transfer pad 10 but causes no problem in electrical connection can be confirmed. This can add and bring into effect a new determination criterion. For example, in FIG. 3, the finish diameter of the transfer 11 is smaller than it should be due to apparatus variations. According to the first prior art, when the diameter of the transfer 101 is smaller than that of the transfer pad 100 in this manner, even if the transfer 501 has a diameter equal to or larger than the maximal NG diameter, this panel is determined as an NG product because it cannot be confirmed.

According to the second prior art, when the diameter of the transfer 501 is small, it cannot undergo NG determination unless its length is measured. Regarding this, according to the present invention, the diameter of the region 10a surrounded by the slits 14 is determined as the maximal NG diameter of the transfer 11. If the transfer 11 can be confirmed from the slits 14, no problem occurs in electrical connection, and accordingly this panel can be immediately determined as a G product. Thus, a G product will no longer be erroneously determined as an NG product. This improves the yield.

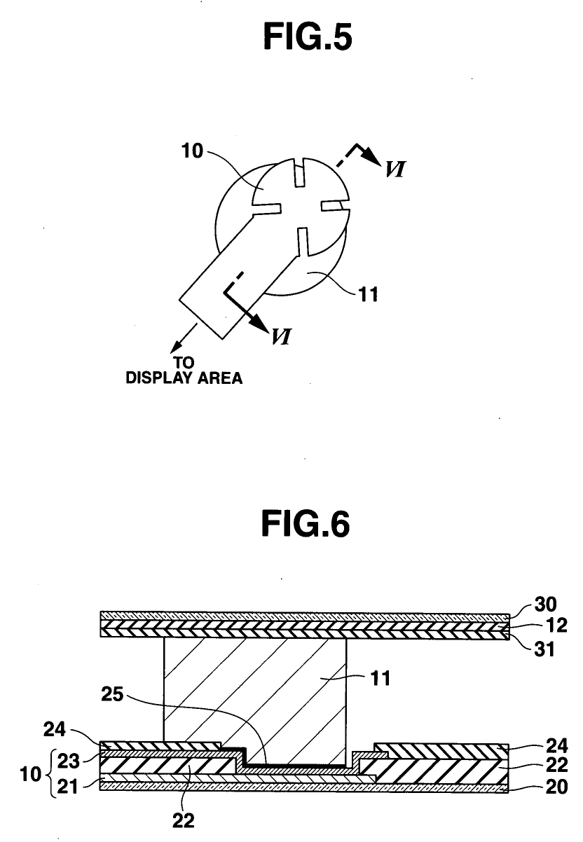

FIG. 5 is a plan view of the transfer pad 10, seen from the TFT substrate 20 side, when the transfer 11 has a positional error due to apparatus variations, and FIG. 6 is a sectional view taken along the line VI-VI′ of FIG. 5.

According to the second prior art, when the size of the transfer 501 exceeds the size of the confirmation window formed in the metal film, the relative positional error between the transfer pad and the countersubstrate 700 cannot be confirmed at all. With the transfer pad 10 of the present invention, even when the coating position of the transfer 11 may be shifted due to apparatus variations, since the slits 14 are provided, the normal transfer 11 can be easily confirmed from the TFT substrate 20 side. According to the second prior art, the transfer confirmation window 503 formed in the transfer pad must have such a size that the entire transfer 501 can be seen through it. This inevitably increases the diameter of the transfer pad. According to the present invention, only slits need be formed that linearly remove part of the peripheral portion of the transfer pad, and the slits need not have such a size that the entire transfer 11 can be seen through it. Thus, the transfer pad 10 need not be large. This allows downsizing of the entire liquid crystal display panel.

As the transfer pad 10 according to the present invention can be formed from the same material and with the same patterning step as those of the process of forming the TFT, no new process need be added. The slits 14 according to the present invention are superior in that they are formed so as to allow the normal transfer 11 to be seen from the TFT substrate 20 side through the slits 14 irrespective of at what position the normal transfer 11 may overlap the transfer pad 10.

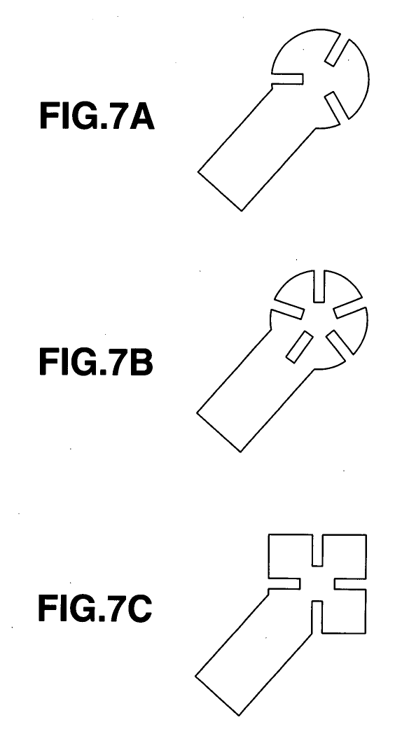

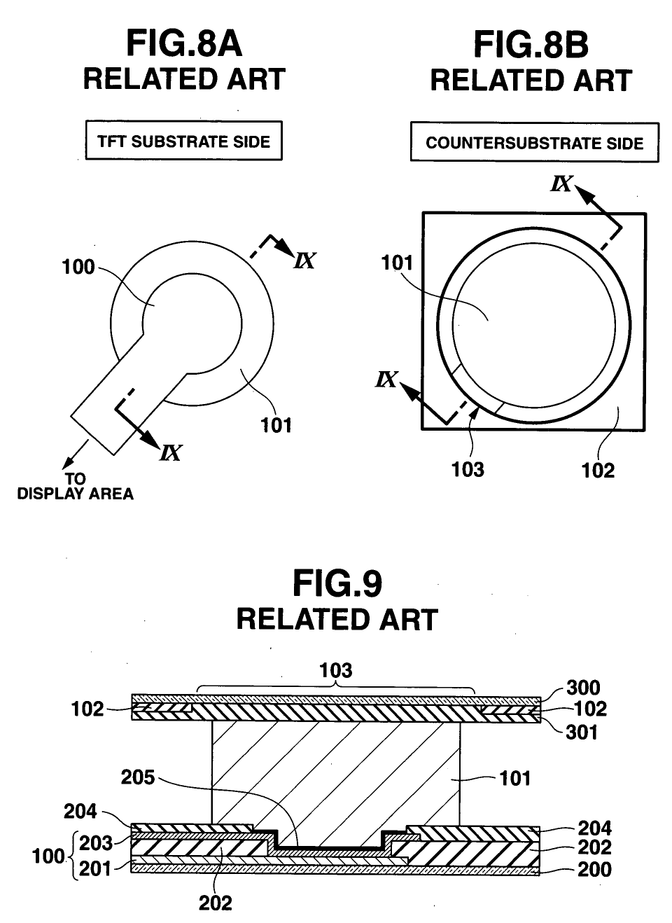

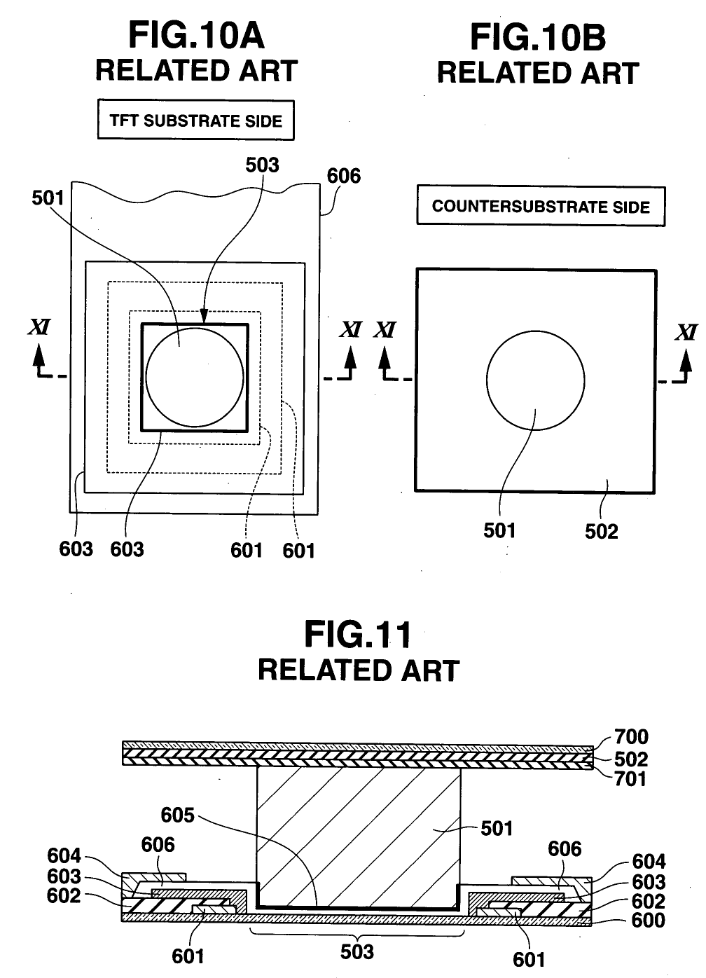

Each of FIGS. 7A, 7B, and 7C shows the shapes of the transfer pad 10 and slits 14. The number of the slits 14 may be three, as shown in FIG. 7A, or five, as shown in FIG. 7B. The transfer pad 10 may have a square shape, as shown in FIG. 7C.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display panel comprising:
a substrate provided with a transfer pad;
a countersubstrate provided with a black mask; and
a transfer arranged between the transfer pad of the substrate and the black mask of the countersubstrate,
wherein the transfer pad includes slits allowing a normal transfer to be seen from a substrate side.

2. A panel according to claim 1, wherein the countersubstrate includes a counterelectrode lied between the black mask and the transfer and electrically connected to the transfer pad through the transfer.

3. A panel according to claim 1, wherein the slits comprise notches formed in a peripheral portion of the transfer pad and spaced apart from each other.

4. A panel according to claim 1, wherein the transfer pad includes a region surrounded by slit terminal ends that are innermost portions of the respective slits.

5. A panel according to claim 4, wherein the region is set to coincide with a region of the transfer when the transfer takes a maximal diameter among small diameters that cause defective electrical connection.

6. A panel according to claim 1, wherein the slits are formed by linearly removing part of a peripheral portion of the transfer pad.

7. A panel according to claim 1, wherein the slits are formed not within a predetermined diameter from a center of the transfer pad but outside the predetermined diameter.

8. A panel according to claim 1, wherein the slits are formed radially in portions of the transfer pad of the substrate.

9. A panel according to claim 1, wherein the slits have such lengths that slit terminal ends that are innermost portions of the respective slits coincide with an edge of a region of the transfer when the transfer takes a maximal diameter among small diameters that cause defective electrical connection.

10. A panel according to claim 1, wherein the slits are formed so that the normal transfer is seen from a substrate side irrespective of at what position the normal transfer may overlap the transfer pad.

11. A panel according to claim 1, wherein the substrate is further provided with a thin film transistor, and the transfer pad is formed from the same material and with the same patterning step as those of part of a process of forming the thin film transistor.

12. A method of testing a liquid crystal display panel comprising the steps of:
preparing a liquid crystal panel including a substrate provided with a transfer pad, a countersubstrate provided with a black mask, and a transfer arranged between the transfer pad of the substrate and the black mask of the countersubstrate and including slits; and
confirming the transfer from a substrate side through the slits.

13. A method according to claim 12, wherein the countersubstrate includes a counterelectrode lied between the black mask and the transfer and electrically connected to the transfer pad through the transfer.
